(19) United States
(12) Patent Application Publication
(10) Pub. No.: US 2006/0165296 A1
(43) Pub. Date: Jul. 27, 2006

(54) Video coding and decoding method

(76) Inventors: Cecile Dufour, Paris (FR); Gwenaelle Marquant, Liffre (FR); Stephane Valente, Paris (FR)

Correspondence Address: PHILIPS INTELLECTUAL PROPERTY & STANDARDS, P.O. BOX 3001, BRIARCLIFF MANOR, NY, 10510, US

(21) Appl. No.: 10/541,006

(22) PCT Filed: Dec. 22, 2003
(86) PCT No.: PCT/IB03/06212

§ 371 Date: Jun. 28, 2005

(30) Foreign Application Priority Data
Dec. 30, 2002 (EP) 02293258.6

(51) Int. Cl. G06K 9/36; G06K 9/46

(52) U.S. Cl. 382/232

(57) ABSTRACT

The invention relates to a video coding method applied to an original video sequence in which the successive frames or video object planes (VOPs) include one or several arbitrarily shaped video objects (VOs) defined by their texture and motion components and an additional shape component. According to the invention, said method comprises a non object-oriented coding step applied to a small numer of frames of the video sequence, an object-oriented coding step, applied to all the frames of the sequence that follow said small number of frames, and a sequencing step, provided for controlling that said non object-oriented and object-oriented coding steps are respectively applied to the appropriate frames, in order to generate a coded bitstream including non object-oriented coded data corresponding to said small number of frames followed by object-oriented coded data corresponding to said folluwing frames. The invention also relates to a corresponding video decoding method.

### FIELD OF THE INVENTION

The present invention generally relates to the field of video compression and, more particularly, to the video coding standards of the MPEG family and to the video coding recommendations of the ITU-H.26X family. More precisely, it relates to a video coding method applied to an original video sequence in which the successive frames or video object planes (VOPs) include one or several arbitrarily shaped video objects (VOs) defined in each VOP by their texture and motion components and an additional shape component, and to a corresponding decoding method.

### BACKGROUND OF THE INVENTION

In the first video standards and recommendations (up to MPEG-2 and H.263 respectively), the video, assumed to be rectangular, was described in terms of three separate channels: one for luminance and two for chrorninance (this three-channels based representation scheme has also been used with other compression schemes like mesh-based approaches). However, artifacts appear when a scene that has to be coded and transmitted and/or stored is composed of several objects with independent movements, especially each time there is a spatio-temporal discontinuity. These areas then need to be specifically treated and refined.

With the MPEG-4 standard, an additional channel has been introduced: the alpha channel, also referred to as the “arbitrary shape channel” in MPEG-4 terminology. This alpha channel allows to describe independently the contour (or shape) of each video object (VO) present in the concerned scene and consequently makes it possible to encode separately objects while avoiding discontinuities along the boundaries of these objects. However, a drawback of such a technique is the waste of bits which is encountered in the cost of the overhead required to describe this shape channel.

### SUMMARY OF THE INVENTION

It is therefore an object of the invention to propose a coding method with which said drawback is avoided.

To this end, the invention relates to a video coding method such as defined in the introductory paragraph of the description, said method ftuther comprising the following steps:
(a) a non object-oriented coding step, applied to a small number of frames of the video sequence;
(b) an object-oriented coding step, applied to all the frames of the sequence that follow said small number of frames;
(c) a sequencing step, provided for controlling that said non object-oriented and object-oriented coding steps are respectively applied to the appropriate frames, in order to generate a coded bitstream including non object- oriented coded data corresponding to said small number of frames followed by object-oriented coded data corresponding to said following frames.
It is also an object of the invention to propose a video decoding method applied to a coded bitstream corresponding to an original video sequence in which the successive frames include one or several arbitrarily shaped video objects (VOs) defined by their texture and motion components and an additional shape component and have been coded by means of a video coding method comprising the following steps:
(a) a non object-oriented coding step, applied to a small number of frames of the video sequence;
(b) an object-oriented coding step, applied to all the frames of the sequence that follow said small number of frames;
(c) a sequencing step, provided for controlling that said non object-oriented and object-oriented coding steps are respectively applied to the appropriate frames, in order to generate a coded bitstream including non object-oriented coded data corresponding to said small number of frames followed by object-oriented coded data corresponding to said following frames; said decoding method itself comprising the following steps:
(1) a first decoding step, applied to said non object-oriented coded data of the coded bitstream that correspond to said small number of frames of the original video sequence;
(2) a spatio-temporal segmentation step applied to said non object-oriented coded data of the coded bitstream that correspond to said small number of frames and provided for reconstructing the missing shape component of the VOs;
(3) a second decoding step, applied to said object-oriented coded data of the coded bitstream that correspond to said following frames;
(4) a sequencing step, provided for controlling that said decoding and segmentation steps are respectively applied to the appropriate frames.

### DETAILED DESCRIPTION OF THE INVENTION

Many documents, and for instance the document U.S. Pat. No. 6,026,195, describe an object-oriented video encoding method and device according to the MPEG-4 standard. The video input of said device is composed of video objects (VOs) and organized in the form of a sequence of digital video images such as video object planes (VOPs), each of which is defined by three components: shape, motion and texture. The encoding device includes a shape encoder, which encodes a particular representation of the shape of each object, a texture encoder, which encodes a representation of the texture of each VO, and a motion encoder, which encodes a representation of the motion of each VO.

Signals representative of the encoded shape, texture and motion of the VOs are then sent to a multiplexer which provides a multiplexed data stream to a buffer. The output of said buffer is then transmitted over a channel or stored in a recording medium such as a database, for a future use, in order to be at a later time received by a demultiplexer, that separates the received coded data, and a decoding device. Said decoding device in turn includes a shape decoder, a texture decoder and a motion decoder, the outputs of which are sent to a reconstruction device, for instance a compositor (such as a personal computer located at a user's home). In said reconstruction device, the received VOPs are processed, and a sequence of video images thus reformed can be output (for example, displayed or stored in a video library).

With respect to such a known system, the principle of the invention is to modify both the encoding and decoding parts by performing on the concerned input sequence a segmentation both at the encoding and decoding sides. In view of the implementation of said principle, a sequencing module is added in the encoding device, in order to force the following operations:

(a) for a small number of frames (or images) of the sequence, and preferably only the two first ones, the shape component of the VOs in the VOPs is not transmitted: the object-oriented coding mode is not chosen for these two first images, and these two images are coded according to a non object-oriented coding mode, for example according to a block-based mode, as if they were one single, rectangular object (this mode is here called “classical”), or a mode based on a wavelet decomposition;

(b) the following frames (i.e. the third one, the fourth one, etc, if only two frames have been considered in the operation (a)) of the sequence are again coded using the object-oriented coding mode, however without transmitting any shape component.

In the decoding device, a sequencing module is correspondingly provided in order to carry out the following operations:

(a) the non object-oriented coded data corresponding to the two first images are “classically” decoded by means of a first decoding step (i.e., as seen above, according for example to the block-based mode or the wavelet-based mode);

(b) a spatio-temporal segmentation step is carried out, based on these two first images;

(c) the object-oriented coded data corresponding to the so-called following images (i.e all the images except the two first ones) are decoded according to the object-oriented decoding mode by means of a second decoding step, the shape information for each VOP being obtained thanks to the spatio-temporal segmentation process provided in the decoding device.

With this technical solution, an object-based processing can be achieved without encoding the shape information, and it thus avoids a waste of bits.

It must be noted that this disclosure is illustrative and that the method according to the present invention is not limited to the aforesaid implementation. The segmentation process may for instance be slightly improved by transmitting in the coded bitstream at the picture level an information on the number of regions of interest (i.e. of VOs in each VOP). In this manner, the decoding device can adjust the segmentation step in order to obtain exactly the same segmentation that the one at the encoder side.

1. A video coding method applied to an original video sequence in which the successive frames or video object planes (VOPs) include one or several arbitrarily shaped video objects (VOs) defined in each VOP by their texture and motion components and an additional shape component, said method comprising the following steps
(a) a non object-oriented coding step, applied to a small number of frames of the video sequence ;
(b) an object-oriented coding step, applied to all the frames of the sequence that follow said small number of frames;
(c) a sequencing step, provided for controlling that said non object-oriented and object-oriented coding steps are respectively applied to the appropriate frames, in order to generate a coded bitstream including non object-oriented coded data corresponding to said small number of frames followed by object-oriented coded data corresponding to said following frames.

2. A coding method according to claim 1, in which said number of frames is equal to two.

3. A coding method according to claim 1, wherein said coded bitstream also includes an information about the number of regions of interest in the original video sequence.

4. A coding method according to claim 3, wherein said information about the number of regions of interest is given at the picture level.

5. A video decoding method applied to a coded bitstream corresponding to an original video sequence in which the successive frames or video object planes (VOPs) include one or several arbitrarily shaped video objects (VOs) defined in each VOP by their texture and motion components and an additional shape component and have been coded by means of a video coding method comprising the following steps:
(a) a non object-oriented coding step, applied to a small number of frames of the video sequence ;
(b) an object-oriented coding step, applied to all the frames of the sequence that follow said small number of frames;
(c) a sequencing step, provided for controlling that said non object-oriented and object-oriented coding steps are respectively applied to the appropriate frames, in order to generate a coded bitstream including non object-oriented coded data corresponding to said small number of frames followed by object-oriented coded data corresponding to said following frames;
said decoding method itself comprising the following steps
(1) a first decoding step, applied to said non object-oriented coded data of the coded bitstream that correspond to said small number of frames of the original video sequence;
(2) a spatio-temporal segmentation step applied to said non object-oriented coded data of the coded bitstream that correspond to said small number of frames and provided for reconstructing the missing shape component of the VOs;
(3) a second decoding step, applied to said object-oriented coded data of the coded bitstream that correspond to said following frames;
(4) a sequencing step, provided for controlling that said decoding and segmentation steps are respectively applied to the appropriate frames.
